(19) United States
(12) Patent Application Publication
(10) Pub. No.: US 2004/0079755 A1
(43) Pub. Date: Apr. 29, 2004

(54) Multi-functional lid for cookware

(76) Inventor: Richard Graus, Reston, VA (US)

Correspondence Address: BRADFORD E. KILE (REG. 25,223), KILE GOEKJIAN LERNER & REED PLLC, 655 15TH STREET, NW, SUITE 475A, WASHINGTON, DC, 20005, US

(21) Appl. No.: 10/280,027

(22) Filed: Oct. 25, 2002

(51) Int. Cl. A47J 37/01; B65D 43/18; A47J 27/00

(52) U.S. Cl. 220/253; 220/912; 220/573.1; 220/254.8; 220/259.4; 220/369

(57) ABSTRACT

A multi-functional lid for cookware having a rotatable disc element and a stationary disc element. The rotating disc element of the lid allows for access related cooking tasks to be performed without removing the lid. The segmented rotating disc element includes an opening that allows for access to the pot, a perforated opening which allows for the controlled release of heat, and a segment that has no openings which allows the lid to contain all heat and moisture under the lid.

### BACKGROUND OF THE INVENTION

### Field of the Invention

The present invention relates to a multi-functional lid for cookware. More specifically, the invention is directed to providing an apparatus that allows for access to the inside of cookware, and for the controlled release of steam and/or draining without removing the lid.

In the past, lids for cookware have not allowed access to a covered container, such as a pot or pan, without first removing the lid. Frequent access is desirable for smelling, tasting, viewing stirring, adding ingredients, etc. Removing a lid from a stove top pot or pan can result in an undesired loss of moisture and heat as well as an annoying “puff” of steam into a person's face. In addition, a hot lid is inconvenient to handle, requiring the lid to be placed in another location or holding the lid while tending to the contents being cooked.

Current cookware lids for pots and pans allow some tasks to be performed without removing the lid, but do not allow multi-functional access to the contents of the cookware without removing the lid. More specifically, one manifestation of cookware in the prior art allows a user of cookware to strain the contents of the cookware without removing the lid. However, this particular prior art does not allow access to the contents within the cookware without removing the lid, and in this respect the lid of this design is no different than conventional one piece lid designs.

When using cookware, a variety of tasks may need to be performed on the contents that are being cooked, such as stirring, adding ingredients, tasting, etc. Using cookware in the prior art, it is not possible to complete these tasks without first removing the lid of the cookware if a lid is being used. Additionally, the cookware lid minimizes splatter due to gases escaping during fluid boiling. Using prior art cookware when one cooks sauces, the lid of the cookware must be removed, exposing the entire open area of the cookware, and the sauce may splatter onto a surface surrounding the source of heat or even on a burner which usually evaporates and leaves burned residue on the burner element. The present invention reduces the amount of area exposed and minimizes the potential for unwanted splatter. Moreover, less splatter reduces the chances of a user being burned and provides a cleaner cooking process, requiring less clean up of a cooking area.

Although conventional cookware lids have been used for decades, it would be desirable to provide a multi-functional lid for cookware that allows access to the contents within a container, such as a pot or pan, being cooked without requiring removal of the lid. It would be further desirable to provide an apparatus that also allows for controlled release of heat and moisture, preventing any unwanted and unexpected release. It is common to have an unwanted release of heat simply by lifting a conventional lid from a pot or pan.

The difficulties, limitations and desires suggested in the preceding are not intended to be exhaustive, but rather are among many which demonstrate that prior art lids for cookware will admit to worthwhile improvement.

### OBJECTS OF THE INVENTION

It is, therefore, a general object of the invention to provide a multi-functional lid for cookware which will eliminate or minimize problems of the type previously described.

It is another general object of the invention to provide a multi-functional lid that will allow a user of cookware to have access to the inner contents of cookware without removing the lid.

It is a specific object of the invention to provide a multi-functional lid that will allow a user of cookware to control the release of heat and moisture within the cookware's cooking environment.

It is another object of the invention to provide a multi-functional lid that will provide increased safety and cleanliness in the cooking process.

It is a further object of the invention to provide a multi-functional lid that will allow an adjustable opening to be made in a cookware lid.

It is yet another object of the invention to provide a multi-functional lid that will permit a cookware lid for allowing different cooking related tasks to be performed without removal of the lid from a pot or pan.

### SUMMARY OF THE INVENTION

To achieve at least some of the foregoing objects, the subject invention comprises a multi-functional lid for cookware. The present invention comprises an adjustable lid including an upper disc portion and a lower disc portion connected in the center where a central knob assembly is located. In the preferred embodiment, the upper disc portion of the cookware lid is rotated by turning a separate knob or handle, while the lower disc portion of the cookware lid remains stationary and operably engages a peripheral edge of the cookware. Near the edge of the lid, the upper disc portion and the lower disc portion come into contact with each other, and the abutting segments of the upper disc portion is allowed to slide over the adjacent lower disc portion while maintaining a lateral steam barrier for the lid.

The upper disc portion of the cookware lid comprises three segments. The first segment is an arcuate opening. The second segment is an arcuate perforated section that is shorter in expanse than the other segments of the upper disc portion of the cookware lid and may be used as a colander and for controlled release of heat and moisture. The third segment is a closed section that is the largest segment, in arcuate expanse, and functions as a conventional cookware lid. The arcuate expanse of all three segments collectively sums to 360 degrees. Thus, the smaller the first segment, the larger will be the third segment or second segment or both.

The lower disc portion of the cookware lid comprises two segments. The first segment is a closed portion that has an arcuate expanse that is greater than or equal to the arcuate expanse of the second segment of the lower disc portion of the cookware lid. The second segment is an open segment, which is less than or equal to the first segment of the lower portion in arcuate expanse. The two segments of the lower disc portion add to 360 radial degrees, and are operably stationary as opposed to the upper rotatable disc portion.

The relationship between the arcuate expanses of the segments of the upper and lower disc portions of the cookware lid differ depending on the embodiments of the invention. For example, in one embodiment the arcuate expanse of the first segment of the upper disc portion may be equal to or less than the second segment of the lower disc portion, and the second and third segments of the upper portion may be equal to or greater than the first segment of the lower disc portion. Many different embodiments of the subject invention are available based on the relationships between the arcuate expanses of the segments of the upper and lower disc portions of the cookware lid.

The aforementioned paragraphs are illustrative of one preferred embodiment of the subject invention. However, many variations are possible. For instance, the lower disc portion may be composed of three segments and the upper disc portion may be composed of two. Also, the lower portion may be the rotatable element as opposed to the upper portion.

Providing a multi-functional, rotating, cookware lid allows cooking to be more convenient. The convenience of the present invention lies in the ability to perform multiple functions without removing the lid. The multiple functions that the present invention provides includes the following: access to the contents being cooked without removing the lid, controlled release of heat and moisture, use of the cookware lid as a colander, and use of the lid as a conventional cookware lid. Removing a cookware lid creates inconveniences such as finding a location to place the lid, losing more heat and moisture than desired or necessary, and clean up from contents that may boil out of the cookware unexpectedly.

### DRAWINGS

Other objects and advantages of the present invention will become apparent from the following detailed description of preferred embodiments thereof taken in conjunction with the accompanying drawings, wherein:

FIG. 1 is an axonometric view of a multi-functional lid for cookware in accordance with a preferred embodiment of the invention;

FIG. 2 is a plan view of a multi-function lid for cookware;

FIG. 3A is a partial cross-section of one embodiment of an edge of a multi-functional cookware lid, where the lid rests atop a cookware lip;

FIG. 3B is a partial cross-section of one embodiment of an edge of a multi-functional cookware lid, where the lid rests on a stepped cookware lip;

FIG. 3C is a partial cross-section of one embodiment of an edge of a multi-functional cookware lid, where the lid drapes over a cookware lip for a friction fit;

FIG. 3D is a partial cross-section of one embodiment of an edge of a multi-functional cookware lid, where the lid overlaps a cookware lip with a friction fit on the inner margin of the cookware;

FIG. 4 is a partial cross-section of a multi-functional cookware lid, illustrating adjacent grooves in an upper portion and a lower portion for preventing heat and moisture loss;

FIG. 5A is a partial cross-sectional illustration of a central knob assembly for a multi-functional cookware lid that allows for cookware disassembly;

FIG. 5B is a partial cross-sectional illustration of an alternative embodiment of a central knob assembly for a multi-functional cookware lid;

FIG. 6A is a partial cross-section of one embodiment of a handle for rotating an upper portion of a multi-functional cookware lid, where the handle is a knob capable of rotating;

FIG. 6B is a partial cross-section of another embodiment of a handle for rotating an upper portion of a multi-functional cookware lid, where the handle is a bar that is fixed to the upper portion of the lid;

FIG. 6C is a partial cross-section of another embodiment of a handle for rotating an upper portion of a multi-functional cookware lid, where the handle is a bar capable of rotating to “in” and “out” positions, the “in” position being shown; and

FIG. 6D is a partial cross-section of yet another embodiment of a handle for rotating an upper portion of a multi-functional cookware lid, where the handle is a bar capable of rotating to “in” and “out” positions, the “out” position being shown.

### DETAILED DESCRIPTION

Referring now to the drawings wherein like numerals indicate like parts, the present invention comprises a multi-functional cover or lid for cookware. Cookware that would benefit from a multi-functional lid include, but are not limited to: 1) stove-top cookware, 2) oven roasting cookware, 3) microwave cookware, 4) crackpots, 5) stewing pots, and 6) clam steamers. The composition of the materials making up a multi-functional cookware lid depend on the cookware to which it is to affixed and the cookware's intended use. The material composition may include: metal (aluminum, iron, copper, etc.); glass or pyrex; and microwavable materials.

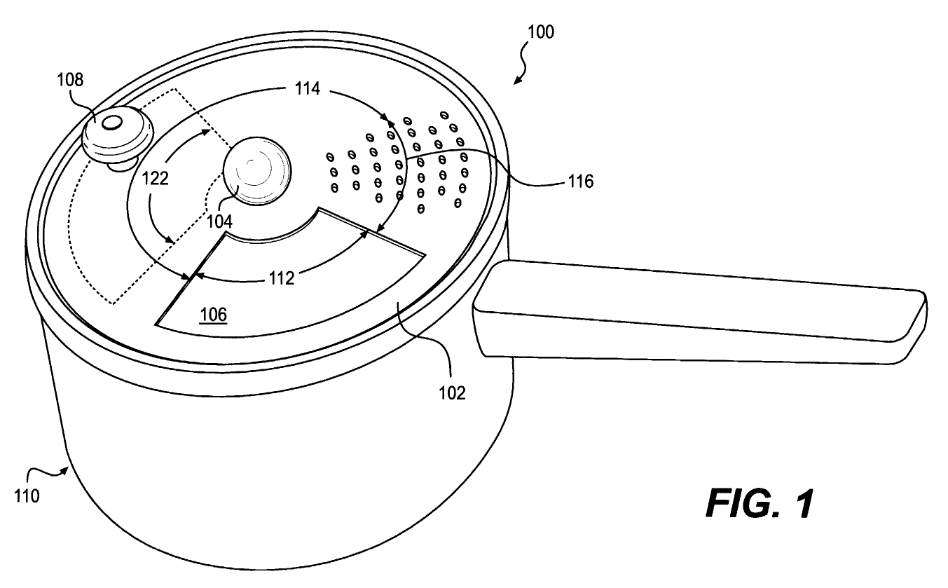

Referring to FIG. 1, an axonometric view of one embodiment of a multi-functional cookware lid 100 is shown. This view illustrates the relationship between the cookware lid 100 and the cookware 110. A central knob assembly 104 is positioned in the radial center of the cookware lid 100, allowing the lid to be facilely removed from the cookware 110 as desired. The lid includes an upper, generally circular, disc portion 102 which is positioned above a lower, generally circular, disc portion 106. A rotation member 108 allows a user of the cookware lid 100 to safely rotate the upper disc portion 102 relative to the lower disc portion 106. In this particular embodiment the upper disc portion 102 is composed with three distinct segments: (1) an arcuate open segment 112; (2) a closed segment 114; and (3) a perforated segment 116.

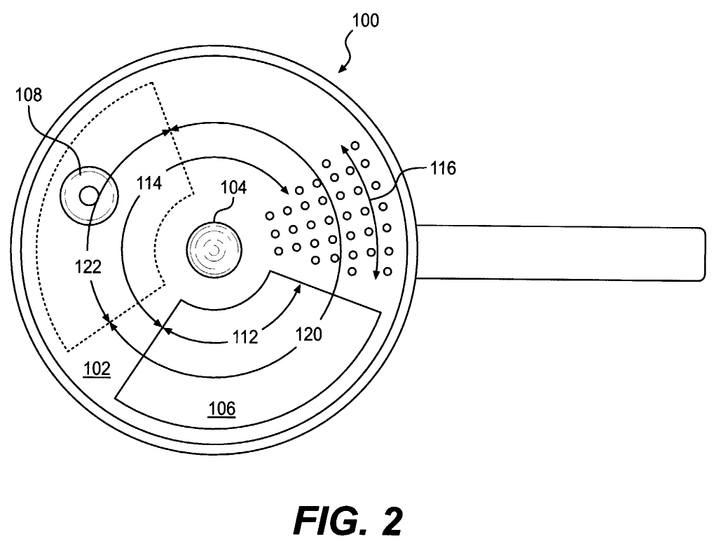

Referring to FIG. 2, a plan view of a multi-functional lid for the cookware of FIG. 1 is shown. This view of the cookware lid 100 illustrates the segmentation of the upper, generally circular, disc portion 102 of the cookware lid 100. Furthermore, this view illustrates the relationship between the upper disc portion 102 and the lower disc portion 106 of the cookware lid. The upper disc portion 102 is positioned above the lower disc portion 106. The lower disc portion 106 is divided into a closed segment 120 and an arcuate open segment 122.

As noted above, the upper disc portion 102 is divided into three segments: (1) an arcuate open segment 112; (2) a closed segment 114; and (3) a perforated segment 116. The open segment 112 is preferably an arcuate opening that allows access to the contents being cooked within the cookware. The arcuate expanse of the opening is preferably about 90 degrees, but may vary significantly. The closed segment 114 is a covering that is preferably greater than 180 degrees, in arcuate expanse, and is greater than the open segment 122 of the lower disc portion 106, allowing the multi-functional cookware lid 100 to be used as a conventional closed cookware lid. The perforated segment 116 features a series of holes for releasing heat and moisture. If the open segment 112 is designed to be small, then the perforated segment 116 may be equally larger. The arcuate expanses of all three segments add up to a complete circular expanse of 360 degrees.

The lower portion 106 is divided into two segments: (1) a closed segment 120; and (2) an open segment 122. The closed segment 120 is a disc covering that is preferably between 180 and 210 degrees in arcuate expanse. The open segment 122 preferably matches the open segment 112 of the upper disc portion 102 in terms of arcuate expanse. However, in any event the arcuate expanse of the open segment 122 of the lower disc portion 106 must be at least slightly less than the closed segment 114 of the upper disc portion 102. The two segments of the lower disc portion 106 define a circular base element of the lid and are stationary as opposed to the rotatable upper disc portion 102.

Although the arcuate expanse of each segment may vary, the combined arcuate expanses of the closed 114 and perforated 116 segments of the upper disc portion can not be less than the open segment 120 of the lower disc portion. The arcuate expanse of the closed segment 114 of the upper disc portion must be at least slightly greater than the open segment 122 of the lower disc portion so that the multi-functional lid for cookware can carryout one of its functions, that of a conventional closed cookware lid. The inverse is also true in order for this function to be carried out. Thus, the arcuate expanse of open segment 122 of the lower disc portion must be at least slightly less than to the closed segment 114 of the upper disc portion. In other words, the arcuate expanse of an opening on either the lower or upper disc portions must be less than that of the closed segment of the opposing disc portion.

Other embodiments of a multi-functional lid for cookware in accordance with the subject invention, are based on relationships of the arcuate expanses of the segments of the upper and lower disc portions. In all of the following embodiments, the arcuate expanse of an opening on either the lower or upper disc portions must be less than that of the closed segment of the opposing disc portion. One such embodiment is where an arcuate expanse of the open segment 112 of the upper disc portion is approximately equal to the open segment 122 of the lower disc portion, and the combined arcuate expanses of the closed 114 and perforated 116 segments of the upper disc portion are approximately equal to the closed segment 122 of the lower disc portion. In another embodiment the arcuate expanse of the closed segment 114 of the upper disc portion is slightly greater than the open segment 122 of the lower disc portion, and the combined arcuate expanses of the open 112 and perforated 116 segments of the upper disc portion are slightly less than the open segment 122 of the lower portion. Yet another embodiment exists where the arcuate expanse of the closed segment 114 of the upper disc portion is approximately equal to the closed segment 120 of the lower disc portion, and said arcuate expanse is equal to or greater than the open segment 122 of the lower disc portion. Still a further embodiment is where the combined arcuate expanses of the open 112 and perforated 116 segments of the upper disc portion are at least slightly less than the closed segment 120 of the lower disc portion, and the closed segment 114 of the upper disc portion is approximately equal to the closed segment 120 of the lower portion. The length of the closed segment 114 of upper disc portion being at least slightly greater than the open segment 122 of the lower disc portion.

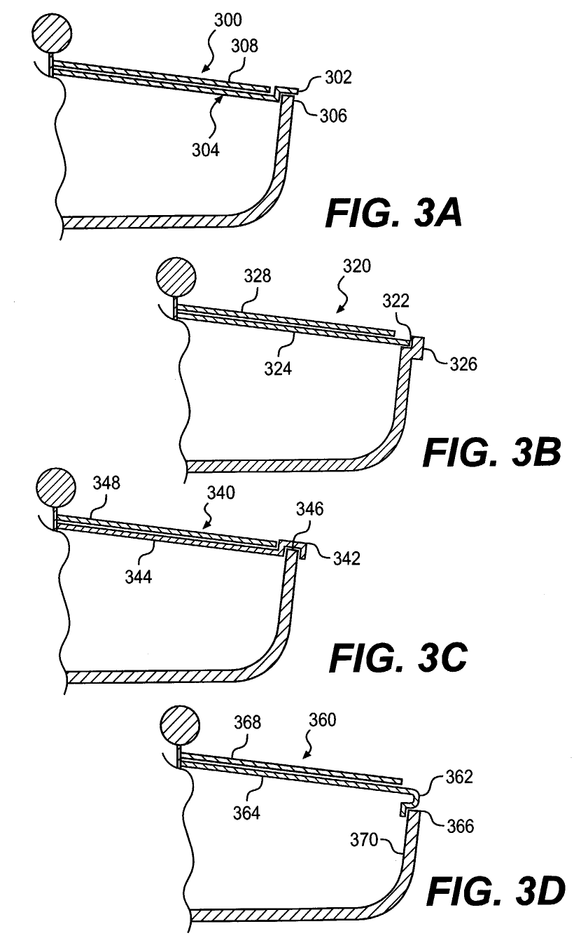

Turning now to FIGS. 3A-3D various embodiments of edge portions of a lid shown in FIGS. 1 and 2 are illustrated. These embodiments allow the multi-functional cookware lid to be securely placed on the lip of corresponding cookware. The embodiments illustrated in the drawings are exemplary, and not exhaustive, however, referring first to FIG. 3A, an edge 302 of a multi-functional cookware lid rests on top of a cookware lip 306. A lower portion 304 of the cookware lid 300 extends radially beyond an upper portion 308 of the lid, and the outermost segment of the lower portion 304 is raised above the lip 306 of the cookware so that the lid 300 will be laterally secure.

Referring to FIG. 3B, an edge 322 of a multi-functional cookware lid 320 rests on a stepped cookware lip 326. A lower portion 324 of the cookware lid 320 extends radially beyond an upper portion 328 of the cookware lid 320, and rests on the step of the cookware lip 326 so that the lid 320 will again be laterally secure.

Referring to FIG. 3C, another embodiment is disclosed in which an edge 342 of a multi-functional cookware lid 340 drapes over and embraces a cookware lip 346. A lower portion 344 of the cookware lid 340 extends radially beyond an upper portion 348, and the edge 342, i.e., the outermost segment of the lower portion 344, is raised up and over the cookware lip 346 for a laterally secure fit. The embracing fit allows the lower portion 344 of the cookware lid to remain stationary.

Referring to FIG. 3D, an edge 362 of a multi-functional cookware lid 360 overlaps a cookware lip 366. A lower portion 364 of the cookware lid 360 extends radially beyond an upper portion 368, and extends to a position overlapping the cookware lip 366, recessing to the inner portion of the cookware 370 with a radially engaging fit. Again, the engaging fit allows the lower portion 364 of the cookware lid 360 to remain stationary.

In all of the aforementioned drawings (FIGS. 3A-3D) the lower disc portion of the cookware lid remains stationary with respect to the upper disc portion, while the upper disc portion is operable to rotate as discussed in connection with FIGS. 1 and 2.

In all of the aforementioned drawings the lower disc portion of the cookware lid is radially extended beyond the upper disc portion, so that the lower disc portion is stationary with respect to a rotating upper disc portion. This relationship may be reversed. The upper disc portion can be constructed so that it radially extends beyond the lower disc portion, and the edge of the upper disc portion fits or rests upon the cookware lip, allowing the upper disc portion to be stationary and the lower disc portion to be capable of rotating.

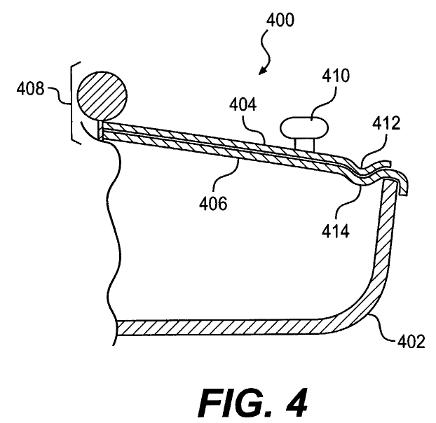

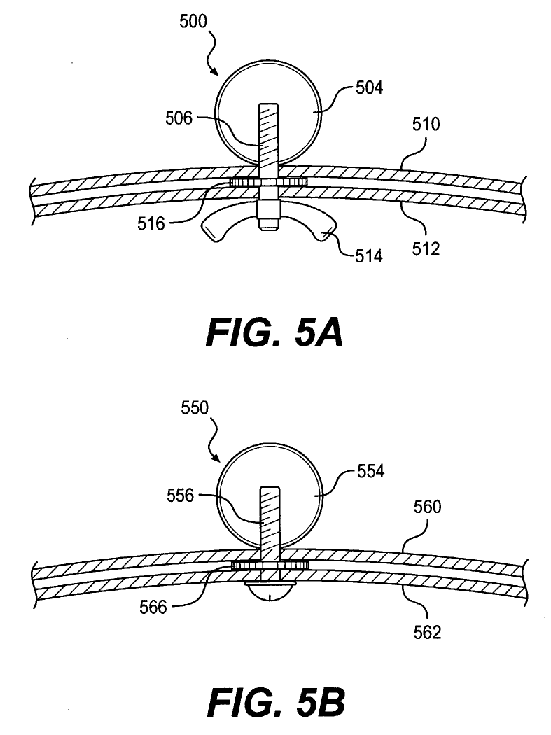

Referring to FIG. 4, a partial cross-sectional view of a multi-functional cookware lid 400 is shown positioned on top of cookware 402. The cookware lid 400 includes an upper portion 404, a lower portion 406, a central knob assembly 408, and a handle 410. The central knob assembly 408 connects the upper portion 404 and the lower portion 406, and allows the upper portion 404 to rotate relative to the lower portion 406 (note FIG. 5A and FIG. 5B). The handle 410 is used to rotate the upper portion 404 without having to touch the upper portion 404, preventing harm from heat, steam, and contents that may boil or spew.

Loss of heat and moisture through lateral seepage can be a concern with a multi-functional cookware lid that has openings in both the upper portion 404 and the lower portion 406. In order to minimize peripheral loss of heat and moisture when the respective segments of the upper portion 404 and lower portion 406 are positioned so that there is no access to the inside of the container, the lower portion 406 has at least one peripheral channel 414 fashioned around the edge of the cookware lid 400, and the upper portion 404 has a corresponding peripheral channel 412. The upper portion channel 412 peripherally nests within the lower portion channel 414, blocking lateral seepage of heat and moisture. Other envisioned embodiments include multiple peripheral channels; channels that are square or rectangular in cross-section as well as other cross-sectional designs. A coating of Teflon, or other lubricant coating, may be applied between the contacting positions of the channel to facilitate rotation while concomitantly blocking the lateral transmission of steam through the lid.

A central knob assembly of the cookware lid connects the upper and lower portions, and allows one portion, either the upper or lower disc, to rotate relative to the other. More specifically and referring to FIG. 5A, an illustration of one embodiment of a central knob assembly 500 for a cookware lid is shown. The central knob assembly 500 includes a knob handle 504, which has a threaded shaft 506 extending through the center of both an upper disc portion 510 and a lower disc portion 512. A wing nut 514 engages a threaded shaft 506 below the lower disc portion 512, securing the central knob assembly 500 in place. A spacer element 516 is placed between the upper disc portion 510 and lower disc portion 512 around the threaded shaft 506, allowing the upper disc portion 510 to rotate relative to the lower disc portion 512, or vice versa. The wing nut 514 also allows the cookware lid to be easily disassembled for cleaning. Further, the wing nut 514 permits an alternative disc combination to be created by replacing the top or bottom disc element.

Referring to FIG. 5B, an alternative embodiment of a central knob assembly 550 for a multi-functional cookware lid is shown. In this embodiment the central knob assembly includes a knob handle 554 which has a thread for allowing a round or flat head bolt 556 to be secured in from below a lower portion 562 of the cookware lid. The bolt 556 extends through the radial center of both an upper disc portion 560 and a lower disc portion 562 into the knob handle 554, securing the central knob assembly 550. The bolt 556 allows the cookware lid to be disassembled for cleaning, albeit not as easily as the embodiment utilizing the wing nut assembly (FIG. 5A) or changing disc elements having a different pattern of segmentation. A spacer element 566 is placed between the upper disc portion 560 and lower disc portion 562 around the bolt 556, allowing the upper disc portion 560 to rotate relative to the lower disc portion 562, or vice versa.

The central knob assemblies, described in FIGS. 5A and 5B, are illustrative of an embodiment of a multi-functional cookware lid in which the central knob assembly is used to rotate either the upper or lower disc portion of a multi-functional cookware lid. In alternative embodiments, the central knob assembly can replace the need for a handle to rotate the rotatable disc element, regardless of whether the rotatable element is the upper or lower disc portion. The central knob assembly can be constructed to allow it to rotate either the upper disc portion or lower disc portion by twisting the knob in either a clockwise or counterclockwise direction. In the event that the central knob assembly is used to rotate the upper disc element, the knob is operably joined to the upper element. Alternatively, when the central knob assembly is used to rotate the lower disc element, the central knob assembly is operably joined to the lower disc element. This is achieved by securing the rotatable element to the central knob assembly and preventing the stationary element from rotating.

Other embodiments of the subject invention with respect to the aspects of the central knob assembly include the ability to have interchangeable or replaceable rotating elements. As noted above, the central knob assembly permits disassembly of the stationary and rotatable elements. This allows for interchangeable multi-functional lid elements to be used. For instance, an interchangeable element could be a rotatable element that has a larger perforated area, has larger perforations, or contains a desired handle. Moreover, disassembly and interchangeable parts permit elements to be replaced if damaged or lost.

Although a central knob assembly may be used to rotate either the upper or lower disc element of the multi-functional cookware lid, a handle often provides more ease of rotational control. A handle may be used as a distinct element, facilitating rotation of the rotatable disc element. Moreover, when a separate knob or handle is utilized to rotate a lower disc, an arcuate groove is fashioned through the upper stationary disc. In this embodiment a circular channel lateral steam barrier is fashioned radially inward of the slot through the upper stationary disc element to prevent the lateral escape of steam.

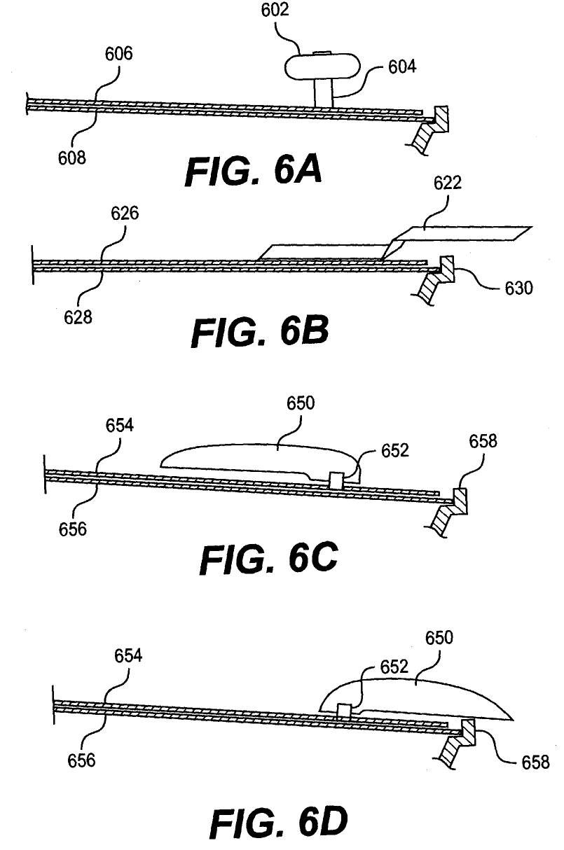

As illustrated in the FIG. 6A-6D sequence of embodiments, numerous separate rotation handle arrangements are contemplated by the subject invention. The following FIGURES and their explanations are intended to be exemplary not exhaustive. Referring to FIG. 6A, a partial cross-sectional view discloses a rotational element as a knob handle 602. The knob handle 602 is capable of rotating, due to its placement on a stand 604 connected to an upper portion 606 of the cookware lid. To rotate the upper portion 606 of the cookware lid relative to the lower portion 608, a user grabs the knob handle 602 and rotates the moveable disc element in the direction desired. As the upper portion 606 is rotated, the knob handle 602 is operable to rotate as well, and a user's grasp on the knob handle 602 need not be modified as the upper portion 606 is rotated.

Referring to FIG. 6B, a partial cross-section of another embodiment of an upper rotational handle is disclosed. A fixed bar handle 622 is attached to an upper portion 626 of a multi-functional cookware lid. The method of securing the fixed bar handle 622 to the upper portion 626 depends on the materials from which the handle and upper portion 626 are made. The fixed bar handle 622, in its preferred embodiment, extends beyond the upper portion 626 and lower portion 628 of the cookware lid and beyond cookware lip 630. Extending the handle 622 in this way provides a degree of remoteness from heat, steam, and boiling liquids.

FIG. 6C and FIG. 6D, refer to the same embodiment of a multi-functional cookware lid's upper portion handle in different positions. The “in/out” bar handle 650 rotates on a short stanchion 652 connected to an upper portion 654 of a multi-functional cookware lid. FIG. 6C shows the “in/out” bar handle 650 rotated into an “in” position. A user may decide to use the handle 650 at the “in” position when cooking in close proximity to other cookware. FIG. 6D shows the “in/out” bar handle 650 at an “out” position. The handle 650 at the “out” position extends beyond the upper portion 654 and lower portion 656 of the cookware lid, and beyond the cookware lip 658. A user may decide to have the handle 650 at the “out” position to isolate the handle from heat, steam, and boiling liquids. This particular embodiment gives the user the flexibility to place the handle 650 in which ever position is desired. One particularly useful feature is to locate the handle 650 in relation to the opening to permit alignment of the rotational handle 650 with a 90 degree angle from the opening to facilitate draining through the side of the lid while holding the rotational handle 650 and pot handle together in alignment. Location of the handle in an “in” or “out” position can be controlled by a detent, pivot or friction arrangement between the stanchion 652 and the handle 650.

### SUMMARY OF MAJOR ADVANTAGES OF THE INVENTION

After reading and understanding the foregoing description of preferred embodiments of the invention, in conjunction with the illustrative drawings, it will be appreciated that several distinct advantages of the subject multi-functional lid for cookware can be realized.

One advantage of the present invention is that it provides improvements in convenience of cooking related tasks. The present invention allows access to smell, stir, taste, view, add ingredients, etc. the contents being cooked in cookware without removing the lid. A related advantage of the present invention is that it allows improved control over the release of heat and moisture within the cooking environment.

Additionally, having a cookware lid with an upper and a lower portion connected in the center of the lid where a knob assembly is located, allows the lid to remain affixed while performing various cooking related functions. The upper disc portion of a lid for cookware, which is capable of rotating by turning a handle or knob, can be segmented into regions for particular functions, while the lower disc portion remains stationary with respect to the upper portion. Alternatively, the lower portion of a cookware lid can be capable of rotating and segmented into regions for particular functions, while the upper portion remains stationary.

Another advantage of the present invention is that it has the ability to be disassembled for cleaning while also allowing rotatable or stationary elements to be interchanged or replaced. Stationary or rotatable elements are interchangeable based on the needs of the cooking task or to replace lost or damaged elements.

A further advantage of the present invention is that it provides for a safer cooking process, stirring through the lid, draining through the lid, and a cleaner cooking environment. The present invention allows an apparatus that increases convenience when performing cookware related task, allows a controlled release of moisture and heat, and provides access to the contents being cooked in cookware.

In describing the invention, reference has been made to preferred embodiments and illustrative advantages of the invention. Those skilled in the art, however, and familiar with the instant disclosure of the subject invention, may recognize additions, deletions, modifications, substitutions and other changes that fall within the purview of the subject invention.

What is claimed:

1. A multi-functional lid for cookware comprising:
a lid operable to cover an opening of a cooking container, said lid having a generally circular, rotatable disc element and a generally circular, stationary disc element;
said generally circular, stationary disc element being operable for extending across and engaging a peripheral edge of a cooking container and said generally circular, stationary disc element having at least one opening therethrough; and
said generally circular, rotatable disc element being rotatably connected to said circular stationary disc element and said generally circular, rotatable disc element having an opening through said circular rotatable disc element and an arcuately spaced zone having a plurality of perforations through said circular rotatable disc element; and
means connected to said circular rotatable disc element for rotating said circular rotatable disc element with respect to said circular stationary disc element, wherein access to the contents of associated cookware is permitted through the lid, without removing the lid, by rotating the opening through the rotatable disc element into registry with the opening through the stationary disc element and steam release through the lid can be achieved, without removing the lid, by rotating the zone of a plurality of perforations through the rotatable disc element into registery with the opening in the stationary disc element.

2. A multi-functional lid for cookware as defined in claim 1 and further comprising:
means fashioned within said circular rotatable disc element for engaging with said circular stationary disc element for blocking lateral migration of steam from within a cookware container laterally between said generally circular stationary disc element and said generally circular rotatable disc element.

3. A multi-functional lid for cookware as defined in claim 2 wherein said means for blocking lateral migration of steam comprises:
a peripheral channel fashioned about the outer periphery of said rotatable lid element and received within and dimensionally compatible with a peripheral channel fashioned within the outer periphery of said stationary lid element.

4. A multi-functional lid for cookware as defined in claim 2 wherein:
said circular rotatable disc element is an upper disc element, and said circular stationary disc element is a lower disc element; and
said lower disc element radially extends beyond said upper disc element, and said lower disc element circumferentially contacts the peripheral edge of said container.

5. A multi-functional lid for cookware as defined in claim 2 wherein:
said circular rotatable disc element is a lower disc element, and said circular stationary disc element is an upper disc element; and
said upper disc element radially extends beyond said lower disc element, and said upper disc element circumferentially contacts the peripheral edge of said container.

6. A multi-functional lid for cookware as defined in claim 2 wherein:
said circular rotatable disc element of said multi-functional lid comprises a covered segment greater than, in arcuate expanse, said opening of said circular stationary disc element.

7. A multi-functional lid for cookware as defined in claim 2 wherein:
said circular rotatable disc element and said circular stationary disc element are pivotally connected by a central knob assembly; and
said central knob assembly comprises: (a) a knob, and (b) a securing device.

8. A multi-functional lid for cookware as defined in claim 2 wherein:
said central knob assembly is operable for rotating said circular rotatable disc element with respect to said circular stationary disc element, allowing said multi-functional lid to release heat and moisture and permitting access into a container.

9. A multi-functional lid for cookware as defined in claim 2 wherein:
said multi-functional lid is adapted to cover said container, wherein an edge of said circular stationary disc element rests atop a peripheral edge of said container.

10. A multi-functional lid for cookware as defined in claim 2 wherein:
said multi-functional is adapted to cover said container, wherein an edge of said circular stationary disc element rests on a stepped peripheral edge of said container.

11. A multi-functional lid for cookware as defined in claim 2 wherein:
said multi-functional lid is adapted to cover said container, wherein an edge of said circular stationary disc element fits over a peripheral edge of said container.

12. A multi-functional lid for cookware as defined in claim 2 wherein:
said multi-functional lid is adapted to cover said container, wherein an edge of said circular stationary disc element overlaps a peripheral edge of said container, recessing to an inner portion of said container.

13. A multi-functional lid for cookware as defined in claim 4, further comprising:
a handle, wherein said handle is attached to said circular rotatable disc element, and wherein said handle is operable in assisting the rotation of said circular rotatable disc element.

14. A multi-functional lid for cookware as defined in claim 13, wherein:
said handle of said upper disc element is a knob capable of rotating.

15. A multi-functional lid for cookware as defined in claim 13, wherein:
said handle of said upper disc element is in a fixed position with respect to said circular rotatable disc element.

16. A multi-functional lid for cookware as defined in claim 13, wherein:
said handle of said upper disc element is positioned on a stanchion, wherein said handle may be placed in either a position extending radially outward from said stanchion away from the center of said multi-functional lid, or said handle may be placed in a position extending radially inward from said stanchion towards the center of said multi-functional lid.

17. A multi-functional lid for cookware comprising:
a lid operable to cover an opening of a cooking container, said lid having a generally circular rotatable disc element and a generally circular stationary disc element; and
said generally circular stationary disc element being operable for extending across and engaging a peripheral edge of the cooking container and said generally circular stationary disc element having at least one opening therethrough; and
said generally circular rotatable disc element being rotatably connected to said circular stationary disc element and said generally circular rotatable disc element having an opening through said circular rotatable disc element; and
said circular rotatable disc element and said circular stationary disc element of said multi-functional lid being pivotally connected by a central knob assembly, and said circular rotatable disc element of said multi-functional lid being operable for rotation relative to said circular stationary disc element; and
means connected to said circular rotatable disc element for rotating said circular rotatable disc element with respect to said circular stationary disc element, wherein access to the contents of associated cookware is permitted through the lid, without removing the lid, by rotating the opening through the rotatable disc element into registry with the opening through the stationary disc element and steam release through the lid can be achieved, without removing the lid, by rotating the zone of a plurality of perforations through the rotatable or stationary disc element into registery with the opening in the opposite element; and
means fashioned within said circular rotatable disc element for engaging with said circular stationary disc element for blocking lateral migration of steam from within a cookware container laterally between said generally circular stationary disc element and said generally circular rotatable disc element.

18. A multi-functional lid for cookware as defined in claim 17, wherein said generally circular rotatable disc element further comprises:
an arcuately spaced zone having a plurality of perforations through said circular rotatable disc element.

19. A multi-functional lid for cookware as defined in claim 17, wherein said generally circular stationary disc element further comprises:
an arcuately spaced zone having a plurality of perforations through said circular stationary disc element.

20. A multi-functional lid for cookware as defined in claim 17, wherein:
said circular rotatable disc element is an upper disc element, and said circular stationary disc element is a lower disc element.

21. A multi-functional lid for cookware as defined in claim 17, wherein:
said circular rotatable disc element is an lower disc element, and said circular stationary disc element is a upper disc element.

22. An multi-functional lid for cookware as defined in claim 17, wherein:
said multi-functional lid is adapted to cover said container, wherein an edge of said circular stationary disc element rests atop a peripheral edge of said container.

23. An multi-functional lid for cookware as defined in claim 17, wherein:
said multi-functional lid is adapted to cover said container, wherein an edge of said circular stationary disc element rests on a stepped peripheral edge of said container.

24. An multi-functional lid for cookware as defined in claim 17, wherein:
said multi-functional lid is adapted to cover said container, wherein an edge of said circular stationary disc element fits over a peripheral edge of said container.

25. An multi-functional lid for cookware as defined in claim 17, wherein:
said multi-functional lid is adapted to cover said container, wherein an edge of said circular stationary disc element overlaps a peripheral edge of said container, recessing to an inner portion of said container.

26. An multi-functional lid for cookware as defined in claim 17, wherein:
said circular rotatable disc element of said multi-functional lid being operable for rotation, wherein said central knob assembly is attached to said circular rotatable disc element, and said central knob assembly is operable in assisting the rotation of said circular rotatable disc element.

27. A multi-functional lid for cookware as defined in claim 17 wherein said means for blocking lateral migration of steam comprises:
a peripheral channel fashioned about the outer periphery of said rotatable lid element and received within and dimensionally compatible with a peripheral channel fashioned within the outer periphery of said stationary lid element.
